(19) United States
(12) Patent Application Publication
(10) Pub. No.: US 2025/0269587 A1
(43) Pub. Date: Aug. 28, 2025

(54) ELECTROMAGNETIC INDUCTION BASED ADDITIVE MANUFACTURING SYSTEM

(71) Applicant: KING FAHD UNIVERSITY OF PETROLEUM AND MINERALS, Dhahran (SA)

(72) Inventors: Suhail Hyder VATTATHURVALAPPIL, Dhahran (SA); Rajesh THERAVALAPPIL, Dhahran (SA); Usman ALI, Dhahran (SA)

(73) Assignee: KING FAHD UNIVERSITY OF PETROLEUM AND MINERALS, Dhahran (SA)

(21) Appl. No.: 18/990,048

(22) Filed: Dec. 20, 2024

Related U.S. Application Data
(60) Provisional application No. 63/558,368, filed on Feb. 27, 2024.

(51) Int. Cl. B29C 64/129; B29C 64/264; B29C 64/393; B29K 101/10; B29K 105/16; B29K 505/08; B33Y 10/00; B33Y 30/00; B33Y 50/02; B33Y 70/10

(52) U.S. Cl. CPC B29C 64/129; B29C 64/264; B29C 64/393; B33Y 10/00; B33Y 30/00; B33Y 50/02; B33Y 70/10; B29K 2101/10; B29K 2105/162; B29K 2505/08; B29K 2995/0008

(57) ABSTRACT

An additive manufacturing system based on electromagnetic induction heating is proposed for making three dimensional structures using thermosets. The additive manufacturing system that includes a resin bath containing an electromagnetically sensitive resin liquid, a support platform having an adjustable support platform height such that the support platform can be reversibly submerged in an electromagnetically sensitive resin liquid contained in the resin bath and a support platform adjustment motor connected to the support platform. The system further includes a movable head positioned above the support platform and including an electromagnetic radiation generating device, a head adjustment motor connected to the movable head and configured to adjust a position of the movable head, and a controller configured to control the support platform and the position of the movable head. The movable head is configured to move in a 3D space above the support platform and have the electromagnetic radiation from the movable head heat a portion of the electromagnetically sensitive resin liquid contained directly below the movable head.

### BACKGROUND

### Technical Field

The present disclosure is directed towards three-dimensional printing technologies, and more particularly, directed towards an electromagnetic induction based additive manufacturing system including a resin bath.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Epoxy based polymers are used across a wide variety of industrial, medical, and domestic applications. Epoxy based polymers have high strength, high chemical resistance, and high dimensional stability, even under high temperatures. These properties make expoxy based polymers useful in diverse industries including, aerospace, automotive, marine, and energy. Due to strong crosslinking and covalent characteristics of the epoxy based polymers, they are favored over thermoplastics for major structural applications. Additionally, epoxy based polymers offer superior chemical and temperature resistance, mechanical capabilities, and dimensional stability, when compared to traditional thermoplastics. Further, epoxy resins are promising for uses in lightweight and energy-efficient construction. However, a major drawback of epoxy based resins is difficulty in the processing of epoxy based resins and manufacturing good out of them. Epoxy based resins typically require specialized manufacturing techniques and may be incompatible with standard techniques and machines used for other polymer-based materials such as thermoplastics.

The use of 3D printing techniques are promising for producing epoxy-based polymeric components. 3D printing and associated methods have the potential to transform various industrial sectors, enabling high-value, on-demand manufacturing. The term 3D printing encompasses a variety of addivite manufacutring techniques. [Huang, J., et. al., Processes, 2020, 8, 1138].

Fused Deposition Modeling (FDM) is a widely used 3D printing technique that employs the process of melting and heating materials through an extrusion head, effectively converting them into a semi-liquid (molten) state. During the process, the material of interest (often a thermoplastic) is fed into the printing nozzle. The printing nozzle then heats up the thermoplastic until it reaches a semi-liquid state. Ones reached, the printing nozzle stars extruding the material onto a building platform layer-by-layer until a 3D object is obtained according to an initial design.

Selective laser sintering (SLS) is another type of 3D printing technology that involves using a high-powered laser to selectively fuse or sinter powdered particles together, layer by layer, to build the final object according to a design. Materials used in SLS can range from metals, nylon, glass, and ceramic to polyesters and even mixture of materials. Materials used in SLS printing typically need to be in powdered form (with particle size often ranging between 10-15 microns) to facilitate robust particle fusion. In a typical SLS process, a first layer is formed, a second layer of the powdered material over the finished layer's surface, where the new layer bonds to the previous one.

Stereolithography (SLA) is a 3D printing technology that involves the gradual solidification of a photo-crosslinkable resin, layer by layer. SLA has led to the development of various methods that enhance resolution and material quality of epoxy based production.

However, techniques like SLS and SLA have certain challenges that may include uneven print layout, economically taxing laser systems, low printing pace, low productivity, incompatibility with epoxy based resins, and constraints in resin viscosity. Hence, there is still a requirement for a smart and environmentally friendly method and system to produce epoxy based resin parts efficiently and effectively.

Accordingly, it is one object of the present disclosure to provide an additive manufacturing system and a method of forming cured resin product, which may circumvent the drawbacks of the methods and systems known in the art.

### SUMMARY

According to a first aspect, the present disclosure relates to an additive manufacturing system. In some embodiments, the additive manufacturing system includes a resin bath configured to contain an electromagnetically sensitive resin liquid, a support platform having an adjustable support platform height such that the support platform can be reversibly submerged in the electromagnetically sensitive resin liquid contained in the resin bath, and a support platform adjustment motor connected to the support platform and configured to adjust the adjustable support platform height. In some embodiments, the additive manufacturing system further includes a movable head that includes an electromagnetic radiation generating device and is positioned above the support platform and configured to not be submerged in the electromagnetically sensitive resin liquid contained in the resin bath, a head adjustment motor connected to the movable head and configured to adjust a position of the movable head, and a controller configured to control the support platform by providing a support platform instruction to the support platform adjustment motor and to control the position of the movable head by providing a head instruction to the head adjustment motor. In some embodiments, the resin bath has a bath depth sufficient to allow the support platform to be submerged in the electromagnetically sensitive resin liquid such that an upper surface of the support platform is below a surface of the electromagnetically sensitive resin liquid. In some embodiments, the movable head is configured to be moved in a three-dimensional (3D) space above the support platform such that electromagnetic radiation generated by the electromagnetic radiation generating device is directed to a portion of the electromagnetically sensitive resin liquid contained in the resin bath directly below the movable head. In some embodiments, the electromagnetic radiation from the movable head is configured to heat only the portion of the electromagnetically sensitive resin liquid contained in the resin bath in the vicinity of the the movable head and/or in the range of electromagnetic radiation and thereby cure the electromagnetically sensitive resin liquid in the portion to form a cured resin.

In some embodiments, the electromagnetically sensitive resin liquid includes an epoxy resin, a latent curing agent, and magneto-sensitive particles dispersed in the epoxy resin.

In some embodiments, the magneto-sensitive particles are present in an amount of 5 percent by weight (wt. %) to 45 wt. % based on a total weight of the electromagnetically sensitive resin liquid.

In some embodiments, the magneto-sensitive particles are magnetic nanoparticles having a mean particle size of 5 nanometers (nm) to 500 nm.

In some embodiments, the magneto-sensitive particles are ferromagnetic.

In some embodiments, the magneto-sensitive particles are superparamagnetic.

In some embodiments, the magneto-sensitive particles include at least one selected from the group consisting of an iron alloy, a nickel alloy, a cobalt alloy, an iron oxide, a nickel oxide, and a cobalt oxide.

In some embodiments, the electromagnetic radiation generating device has a power of 25 watts (W) to 250 W.

In some embodiments, the electromagnetic radiation generating device is configured to produce a curing temperature of the electromagnetically sensitive resin liquid of 100° C. to 250° C.

In some embodiments, the electromagnetic radiation generating device is configured to produce the curing temperature of the electromagnetically sensitive resin liquid within 60 seconds of initiating exposure of the electromagnetically sensitive resin liquid to the electromagnetic radiation.

The present disclosure also relates to a method of forming a cured resin product using the additive manufacturing system. In some embodiments, the method includes adjusting the height of the support platform of the additive manufacturing system such that the support platform is submerged in the electromagnetically sensitive resin liquid to a build depth below a surface of the electromagnetically sensitive resin liquid. In some embodiments, the method further includes forming a first cured resin layer by exposing the electromagnetically sensitive resin liquid to electromagnetic radiation generated by the movable head, adjusting the height of the support platform such that the first cured resin layer is submerged in the electromagnetically sensitive resin liquid, and forming a second cured resin layer by exposing the electromagnetically sensitive resin liquid to electromagnetic radiation generated by the movable head. In some embodiments, the second cured resin layer is disposed on the first cured resin layer.

In some embodiments, the forming includes moving the movable head, and the method further includes iteratively forming a plurality of subsequent cured resin layers, each disposed on a previous cured resin layer.

In some embodiments, the electromagnetically sensitive resin liquid includes an epoxy resin, a latent curing agent, and magneto-sensitive particles dispersed in the epoxy resin.

In some embodiments, the magneto-sensitive particles are present in an amount of 5 wt. % to 45 wt. % based on a total weight of the electromagnetically sensitive resin.

In some embodiments, the magneto-sensitive particles are magnetic nanoparticles having a mean particle size of 5 nm to 500 nm.

In some embodiments, the magneto-sensitive particles are ferromagnetic.

In some embodiments, the magneto-sensitive particles are superparamagnetic.

In some embodiments, the magneto-sensitive particles include at least one selected from the group consisting of an iron alloy, a nickel alloy, a cobalt alloy, an iron oxide, a nickel oxide, and a cobalt oxide.

In some embodiments, the exposing the electromagnetically sensitive resin liquid to electromagnetic radiation generated by the movable head causes the electromagnetically sensitive resin liquid to be heated to a curing temperature of 100° C. to 250° C.

In some embodiments, the electromagnetically sensitive resin liquid is fully cured within 60 minutes of an initiation of the exposure.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a schematic diagram of an additive manufacturing system, according to certain embodiments,

FIG. 1B is an exemplary illustration of a structure of an electromagnetically sensitive resin liquid included in the additive manufacturing system, according to certain embodiments;

FIG. 2 is a flow chart of a method of forming a cured resin product from the additive manufacturing system, according to certain embodiments;

FIG. 3A is an optical image of an experimental setup showing a portion of the additive manufacturing system, illustrating an initial stage of an additive manufacturing process, according to certain embodiments;

FIG. 3B is an optical image of the experimental setup showing a portion of the additive manufacturing system, illustrating a final stage of the additive manufacturing process, according to certain embodiments;

FIG. 3C is an optical image of a cured resin product obtained through the additive manufacturing process, according to certain embodiments;

FIG. 4 is a graph depicting a trend of time with respect to temperature of an electromagnetically sensitive resin liquid, according to certain embodiments;

FIG. 5 is an illustration of a non-limiting example of details of computing hardware used in a computing system corresponding to a controller of the additive manufacturing system, according to certain embodiments;

FIG. 6 is an exemplary schematic diagram of a data processing system used within the computing system, according to certain embodiments;

FIG. 7 is an exemplary schematic diagram of a processor used with the computing system, according to certain embodiments; and

FIG. 8 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of the present disclosure are directed towards an additive manufacturing system and a method of forming a cured resin product via the additive manufacturing system. In some embodiments, the system and method of the present disclosure are useful for producing a three-dimensional (3D) component, device, apparatus, or product. In some embodiments, the component, device, or apparatus is formed of or includes a cured resin product, such as a cured epoxy-based resin.

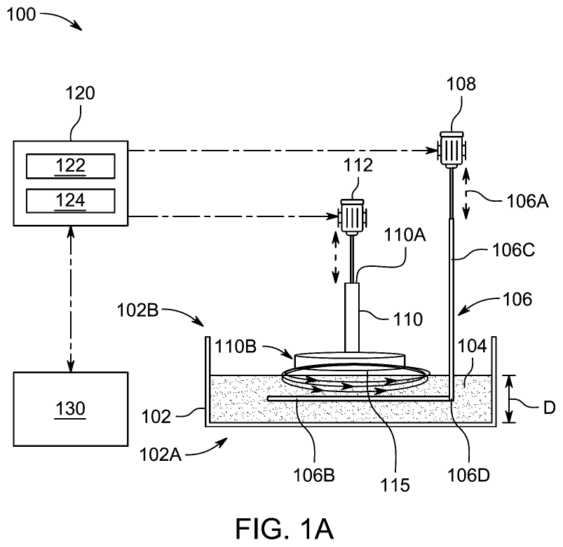

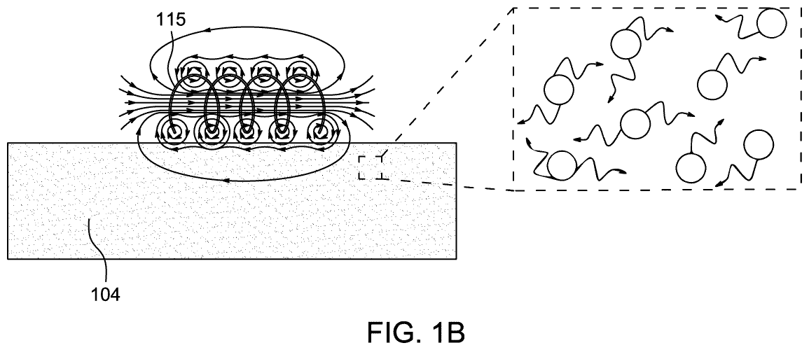

Referring to FIG. 1A, an exemplary additive manufacturing system 100 is illustrated, according to certain embodiments of the present disclosure. FIG. 1A depicts some of the components which may be included in the additive manufacturing system 100. In general, additive manufacturing is a process of creating an object by building the object one layer at a time. Additive manufacturing is inverse of subtractive manufacturing, in which an object is created by cutting away at a solid block of material until the final product is complete.

The exemplary additive manufacturing system 100 includes a resin bath 102 configured to contain an electromagnetically sensitive resin liquid 104. Referring to FIG. 1B, an exemplary illustration of a structure of the electromagnetically sensitive resin liquid 104 is described, according to certain embodiments.

In some embodiments, the electromagnetically sensitive resin liquid 104 includes a curable resin. In general, the curable resin is a type of thermosetting polymer, or plastic. Such resins undergo a curing process that involves chemical and structural changes to form a desired shape. The thermosetting process is typically chemically irreversible in nature. Examples of curable resins include, but are not limited to epoxy resins, urethane resins, polyester resins, acrylate resins, imide resins, amidimide resins, silicone resins, furan resins, phenol resins, phenol formaldehyde resins, and the like. In some embodiments, the electromagnetically sensitive resin liquid 104 includes an epoxy resin. In some embodiments, the electromagnetically sensitive resin liquid 104 includes a latent curing agent. A latent curing agent refers to a chemical capable of curing a resin upon a suitable trigger, typically an increase in temperature or exposure to UV light. Because the curing is initiated upon the trigger, the use of a latent curing agent can be associated with a long pot life of a resin. Examples of suitable latent curing agents include, but are not limited to, dicyandiamides, organic hydrazines, imidazoles, bifunctional phenols, and the like.

In some embodiments, the electromagnetically sensitive resin liquid 104 includes magneto-sensitive particles. In some embodiments, the magneto-sensitive particles are dispersed in the electromagnetically sensitive resin liquid 104. As can be seen from an inset of FIG. 1B, the magneto-sensitive particles provide required magnetism to the electromagnetically sensitive resin liquid. In some embodiments, the magneto-sensitive particles are ferromagnetic. In some embodiments, the magneto-sensitive particles are ferrimagnetic. In some embodiments, the magneto-sensitive particles are superparamagnetic. In some embodiments, the magneto-sensitive particles include at least one selected from the group consisting of an iron alloy, a nickel alloy, a cobalt alloy, an iron oxide, a nickel oxide, and a cobalt oxide. The above mentioned materials may provide the desired ferromagnetic and superparamagnetic properties advantageous for an efficient operation of the additive manufacturing system 100.

In general, the magneto-sensitive particles can be any shape known to one of ordinary skill in the art. Examples of suitable shapes the magneto-sensitive particles may take include spheres, spheroids, lentoids, ovoids, solid polyhedra such as tetrahedra, cubes, octahedra, icosahedra, dodecahedra, hollow polyhedra (also known as nanocages), stellated polyhedra (both regular and irregular, also known as nanostars), triangular prisms (also known as nanotriangles), hollow spherical shells (also known as nanoshells), tubes (also known as nanotubes), nanosheets, nanoplatelets, nanodisks, rods (also known as nanorods), and mixtures thereof. In the case of nanorods, the rod shape may be defined by a ratio of a rod length to a rod width, the ratio being known as the aspect ratio. In some embodiments, the magneto-sensitive particles are nanorods having an aspect ratio less than 1000, preferably less than 750, preferably less than 500, preferably less than 250, preferably less than 100, preferably less than 75, preferably less than 50, preferably less than 25.

In some embodiments, the magneto-sensitive particles have uniform shape. Alternatively, the shape may be non-uniform. As used herein, the term “uniform shape” refers to an average consistent shape that differs by no more than 10%, by no more than 5%, by no more than 4%, by no more than 3%, by no more than 2%, by no more than 1% of the distribution of magneto-sensitive particles having a different shape. As used herein, the term “non-uniform shape” refers to an average consistent shape that differs by more than 10% of the distribution of magneto-sensitive particles having a different shape. In one embodiment, the shape is uniform and at least 90% of the magneto-sensitive particles are spherical or substantially circular, and less than 10% are polygonal. In another embodiment, the shape is non-uniform and less than 90% of the magneto-sensitive particles are spherical or substantially circular, and greater than 10% are polygonal.

In some embodiments, the magneto-sensitive particles have a mean particle size of 5 nanometers (nm) to 500 nm. For example, in certain embodiments, the magneto-sensitive particles have a mean particle size of 10 nm, 15 nm, 20 nm, 25 nm, 30 nm, 35 nm, 40 nm, 45 nm, 50 nm, 55 nm, 60 nm, 75 nm, 80 nm, 95 nm, 100 nm, 110 nm, 125 nm, 150 nm, 175 nm, 200 nm, 225 nm, 250 nm, 275 nm, 300 nm, 325 nm, 350 nm, 375 nm, 400 nm, 425 nm, 450 nm, or 475 nm. In embodiments where the magneto-sensitive particles are spherical, the particle size may refer to a particle diameter. In embodiments where the magneto-sensitive particles are polyhedral or some other non-spherical shape, the particle size may refer to the diameter of a circumsphere. In some embodiments, the particle size refers to a mean distance from a particle surface to particle centroid or center of mass. In alternative embodiments, the particle size refers to a maximum distance from a particle surface to a particle centroid or center of mass. In some embodiments where the magneto-sensitive particles have an anisotropic shape such as nanorods, the particle size may refer to a length of the nanorod, a width of the nanorod, or an average of the length and width of the nanorod. In some embodiments in which the magneto-sensitive particles have non-spherical shapes, the particle size refers to the diameter of a sphere having an equivalent volume as the particle. In some embodiments in which the magneto-sensitive particles have non-spherical shapes, the particle size refers to the diameter of a sphere having an equivalent diffusion coefficient as the particle.

In some embodiments, the magneto-sensitive particles of the present disclosure are monodisperse, having a coefficient of variation or relative standard deviation, expressed as a percentage and defined as the ratio of the particle size standard deviation (o) to the particle size mean (u) multiplied by 100 of less than 25%, preferably less than 10%, preferably less than 8%, preferably less than 6%, preferably less than 5%, preferably less than 4%, preferably less than 3%, preferably less than 2%. In some embodiments, the magneto-sensitive particles of the present disclosure are monodisperse having a particle size distribution ranging from 80% of the average particle size to 120% of the average particle size, preferably 90-110%, preferably 95-105% of the average particle size. In some embodiments, the magneto-sensitive particles are not monodisperse.

In general, the particle size may be determined by any suitable method known to one of ordinary skill in the art. In some embodiments, the particle size is determined by powder X-ray diffraction (PXRD). Using PXRD, the particle size may be determined using the Scherrer equation, which relates the full-width at half-maximum (FWHM) of diffraction peaks to the size of regions comprised of a single crystalline domain (known as crystallites) in the sample. In some embodiments, the crystallite size is the same as the particle size. For accurate particle size measurement by PXRD, the particles should be crystalline, comprise only a single crystal, and lack non-crystalline portions. Typically, the crystallite size underestimates particle size compared to other measures due to factors such as amorphous regions of particles, the inclusion of non-crystalline material on the surface of particles such as bulky surface ligands, and particles which may be composed of multiple crystalline domains. In some embodiments, the particle size is determined by dynamic light scattering (DLS). DLS is a technique which uses the time-dependent fluctuations in light scattered by particles in suspension or solution in a solvent, typically water to measure a size distribution of the particles. Due to the details of the DLS setup, the technique measures a hydrodynamic diameter of the particles, which is the diameter of a sphere with an equivalent diffusion coefficient as the particles. The hydrodynamic diameter may include factors not accounted for by other methods such as non-crystalline material on the surface of particles such as bulky surface ligands, amorphous regions of particles, and surface ligand-solvent interactions. Further, the hydrodynamic diameter may not accurately account for non-spherical particle shapes. DLS does have an advantage of being able to account for or more accurately model solution or suspension behavior of the particles compared to other techniques. In some embodiments, the particle size is determined by electron microscopy techniques such as scanning electron microscopy (SEM) or transmission electron microscopy (TEM).

In some embodiments, the magneto-sensitive particles are present in an amount of 5 percent by weight (wt. %) to 45 wt. % based on a total weight of the electromagnetically sensitive resin liquid 104. However, a concentration of the magneto-sensitive particles may be different from the range defined above, as such, the concentration may be lower or higher, depending upon a use case of the additive manufacturing system 100. For example, in some embodiments, the magneto-sensitive particles are present in an amount of 5.5 wt. %, 6.0 wt. %, 6.5 wt. %, 7.0 wt. %, 7.5 wt. %, 8.0 wt. %, 8.5 wt. %, 9.0 wt. %, 9.5 wt. %, 10.0 wt. %, 10.5 wt. %, 11.0 wt. %, 11.5 wt. %, 12.0 wt. %, 12.5 wt. %, 13.0 wt. %, 13.5 wt. %, 14.0 wt. %, 14.5 wt. %, 15.0 wt. %, 15.5 wt. %, 16.0 wt. %, 16.5 wt. %, 17.0 wt. %, 17.5 wt. %, 18.0 wt. %, 18.5 wt. %, 19.0 wt. %, 19.5 wt. %, 20.0 wt. %, 21.0 wt. %, 22.0 wt. %, 23.0 wt. %, 24.0 wt. %, 25.0 wt. %, 26.0 wt. %, 27.0 wt. %, 28.0 wt. %, 29.0 wt. %, 30.0 wt. %, 31.0 wt. %, 32.0 wt. %, 33.0 wt. %, 34.0 wt. %, 35.0 wt. %, 36.0 wt. %, 37.0 wt. %, 38.0 wt. %, 39.0 wt. %, 40.0 wt. %, 41.0 wt. %, 42.0 wt. %, 43.0 wt. %, 44.0 wt. %, or 45.0 wt. %, based on a total weight of the electromagnetically sensitive resin liquid 104.

Referring to FIG. 1A, in some embodiments, the resin bath 102 has a bath depth ‘D’, defined between a bottom end 102A of the resin bath 102 and a top end 102B of the resin bath 102. In some embodiments, the top end 102B is configured to be open. The top end 102B being open may be advantageous for allowing uninterrupted transmission of electromagnetism to the electromagnetically sensitive resin liquid 104. In some embodiments, the additive manufacturing system 100 includes a support platform 106. In some embodiments, the support platform 106 may have an adjustable support platform height 106A. In some embodiments, the support platform 106 is defined as a structural component of the additive manufacturing system 100. In some embodiments, the support platform 106 includes a base 106B and an arm 106C. In some embodiments, the base 106B and the arm 106C of the support platform 106 are configured to be detachably coupled at a junction point 106D. In some embodiments, the additive manufacturing system 100 includes a support platform adjustment motor 108 connected to the support platform 106. The support platform adjustment motor 108 can be configured to adjust the adjustable support platform height 106A. In some embodiments, the support platform 106 may be mechanically coupled with the support platform adjustment motor 108 at the arm 106C. In some embodiments, a shaft of the support platform adjustment motor 108 may be movably coupled with the arm 106C via a height adjustment mechanism. In some embodiments, the height adjustment mechanism may include a rack and pinion setup, a geared setup, a stepper setup, or some other similarly adjustable setup in order to move the support platform 106. In some embodiments, the adjustable support platform height 106A enables the support platform 106 to be reversibly submerged in the electromagnetically sensitive resin liquid 104 contained in the resin bath 102. In some embodiments, the support platform 106 is configured to move in either an upward direction or a downward direction, and further regain its original position. In some embodiments, movement and/or height of the support platform 106 may be adjusted based or depending upon an input from a user of the additive manufacturing system 100. In some embodiments, movement and/or height of the support platform 106 may be adjusted based or depending upon an instruction provided by a controller as described below. In some embodiments, the resin bath 102 has the bath depth sufficient to allow the support platform 106 to be submerged in the electromagnetically sensitive resin liquid 104. In some embodiments, an upper surface of the support platform 106 can be reversibly placed below a surface of the electromagnetically sensitive resin liquid 104. In some embodiments, submersion of the support platform 106 into the electromagnetically sensitive resin liquid 104 may be advantageous for allowing for curing of the curable resin on top of a layer of an already-cured resin. Such curing can be initiated or caused by exposing an appropriate area of the electromagnetically sensitive resin liquid 104 to electromagnetic radiation as described herein.

In some embodiments, the additive manufacturing system 100 further includes a movable head 110. In some embodiments, the movable head 110 has a top end 110A and a bottom end 110B. In some embodiments, the movable head 110 is disposed above the resin bath 102, in a vertical direction. In some embodiments, the bottom end 110B of the movable head 110 is directly above the resin bath 102. In some embodiments, the top end 110A of the movable head 110 is mechanically coupled with a support component (not shown). Such coupling may facilitate or allow the movable head to receive a structural support from the support component. In some embodiments, the support component is configured to be dynamically adjustable. For example, the support component can be adjustable to provide free motion to the movable head 110 in an area above the support platform. In some embodiments, the movable head 110 may be adjustable in a 3D space. That is, the movable head can adjust in a left-right direction (“x-direction”), a front-back direction (“y-direction”), and an up-down direction (“z-direction”). This may allow the movable head to adjust both a position within a plane parallel to a surface of the resin contained in the resin bath and a height above the surface of the resin contained in the resin bath. In some embodiments, the movable head 110 is positioned above the support platform 106 and configured to not be submerged in the electromagnetically sensitive resin liquid 104 contained in the resin bath 102. In some embodiments, the vertical distance is remotely controlled to prevent submersion of the movable head 110 into the resin bath 102.

The resin bath 102 preferably has an interior top surface that is in contact with the resin during operation having a concave shape. Preferably, a single projection appears at a center point of the resin bath, extending upwards to a height about ¼-¾ or about ⅓-⅔ the total depth of the resin bath. The conical extension preferably includes an asymptotically curved side surface sloping towards the upper surface of the resin bath. This projection is preferably disposed underneath a corresponding or mating convex indentation on a bottom surface of the movable head of the radiation generating device 115. The projection from the bottom of the resin bath is useful for maintaining a constant and equivalent exposure of the resin bath to electromagnetic radiation produced from the electromagnetic radiation generating device 115. In one embodiment, one or more of the electromagnetic radiation generating device and the movable head may at least partially mate with the upwardly extending projection from the interior surface of the resin bath. In this configuration, the device may be quickly brought into condition for activity with minimal delay for maintenance and a lessened risk of damaging a substrate.

In some embodiments, the additive manufacturing system 100 includes a head adjustment motor 112 connected to the movable head 110 and configured of adjust a position of the movable head 110. In some embodiments, the head adjustment motor 112 may be disposed between the support component and the top end 110A of the movable head 110, in order to provide an electrically powered movement capability to the movable head 110, for precise adjustments.

In some embodiments, the movable head 110 includes an electromagnetic radiation generating device 115. In some embodiments, the electromagnetic radiation generating device 115 can be defined at the bottom end 110B of the movable head 110. In general, an electromagnetic radiation generating device may refer to any mechanical or electronic apparatus specifically designed to produce electromagnetic radiation or electromagnetism. In some embodiments, the electromagnetic radiation can be produced across a spectrum of wavelengths, including but are not limited to radio waves, microwaves, infrared, visible light, ultraviolet, X-rays, and gamma rays. In some embodiments, the electromagnetic radiation has a frequency in the radio range, the microwave range, or the infrared range. In some embodiments, the electromagnetic radiation generating device 115 may include an electromagnetic coil, such as a pan-type coil, in order to produce electromagnetic radiation from electrical energy supplied to the electromagnetic radiation generating device 115.

In general, the electromagnetic radiation can interact with the magneto-sensitive particles in the electromagnetically sensitive resin liquid 104. Such interaction can cause an increase in the temperature of the electromagnetically sensitive resin liquid 104. In general, this interaction can be referred to as induction heating, magnetic heating, magnetic induction heating, magnetic field heating, or some other similar term. In some embodiments, the interaction between the electromagnetic radiation and the magneto-sensitive particles in the electromagnetically sensitive resin liquid 104 can cause curing of the resin. In some embodiments, the electromagnetic radiation generating device 115 is configured to produce a curing temperature of the electromagnetically sensitive resin liquid 104 of 100° C. to 250° C. In some embodiments, the curing temperature can be 100° C., 105° C., 110° C., 115° C., 120° C., 125° C., 130° C., 135° C., 140° C., 145° C., 150° C., 155° C., 160° C., 165° C., 170° C., 175° C., 180° C., 185° C., 190° C., 195° C., 200° C., 205° C., 210° C., 215° C., 220° C., 225° C., 230° C., 235° C., 240° C., 245° C., or 250° C., In general, the curing temperature refers to a temperature at which the electromagnetically sensitive resin liquid 104 undergoes a curing reaction as described above. In some embodiments, the electromagnetic radiation generating device 115 is configured to produce the curing temperature of the electromagnetically sensitive resin liquid 104 within 60 seconds, within 55 seconds, within 50 seconds, within 45 seconds, within 40 seconds, within 35 seconds, within 30 seconds, within 25 seconds, within 20 seconds, within 15 seconds, within 10 seconds, or within 5 seconds of initiating exposure of the electromagnetically sensitive resin liquid 104 to the electromagnetic radiation. This time period may be case dependent and may be affected by parameters such as volume of the electromagnetically sensitive resin liquid 104 and ambient temperature of the resin bath 102. In some embodiments, the heating causes latent curing agent to initiate the curing reaction or curing process. In some embodiments, a low curing time may be advantageous for providing more versatility to the additive manufacturing system 100 and may help in reducing production lead times, making the additive manufacturing system 100 more efficient.

In some embodiments, the electromagnetic radiation generating device 115 has a power of watts (W) to 5000 W. In some embodiments, the electromagnetic radiation generating device 115 has a power of 50 W, 75 W, 100 W, 125 W, 150 W, 175 W, 200 W, 225 W, 250 W, 275 W, 300 W, 325 W, 350 W, 375 W, 400 W, 425 W, 450 W, 475 W, 500 W, 525 W, 550 W, 575 W, 600 W, 625 W, 650 W, 675 W, 700 W, 725 W, 750 W, 775 W, 800 W, 825 W, 850 W, 875 W, 900 W, 925 W, 950 W, 975 W, 1000 W, 1050 W, 1100 W, 1150 W, 1200 W, 1250 W, 1300 W, 1350 W, 1400 W, 1450 W, 1500 W, 1550 W, 1600 W, 1650 W, 1700 W, 1750 W, 1800 W, 1850 W, 1900 W, 1950 W, 2000 W, 2100 W, 2200 W, 2300 W, 2400 W, 2500 W, 2600 W, 2700 W, 2800 W, 2900 W, 3000 W, 3100 W, 3200 W, 3300 W, 3400 W, 3500 W, 3600 W, 3700 W, 3800 W, 3900 W, 4000 W, 4100 W, 4200 W, 4300 W, 4400 W, 4500 W, 4600 W, 4700 W, 4800 W, 4900 W, or 5000 W.

In some embodiments, of the present disclosure, the movable head 110 is configured to be moved in a 3D space above the support platform 106, such that electromagnetic radiation generated by the electromagnetic radiation generating device 115 is directed to a portion of the electromagnetically sensitive resin liquid 104 contained in the resin bath 102. In some embodiments, the portion of the electromagnetically sensitive resin liquid 104 is directly below the movable head 110. In some embodiments, the electromagnetic radiation generated by the movable head 110 can be highly localized and/or directed to a small volume of the electromagnetically sensitive resin liquid 104 contained in the resin bath 102. Such localization and/or directing can cause heating in only a small volume of the electromagnetically sensitive resin liquid 104 contained in the resin bath 102. This highly precise heating can induce curing in only a very small volume of the electromagnetically sensitive resin liquid 104. That is, the electromagnetic radiation from the movable head 110 is configured to heat only the portion of the electromagnetically sensitive resin liquid 104 contained in the resin bath 102 directly below the movable head 110 and thereby cure the electromagnetically sensitive resin liquid 104 in the portion to form a cured resin. By moving the movable head, multiple individual volumes of electromagnetically sensitive resin liquid 104 can be cured, thereby forming a cured resin having a precise, yet possibly complicated or intricate structure. In general, the form and complexity of the cured resin may be dependent on several factors including, but are not limited, to a dispersion and size of magneto-sensitive particles, electromagnetic wave focusing, power and frequency of the electromagnetic radiation generating device 115, amperes of the electrical current supplied, as well as the types of coils used in the electromagnetic radiation generating device 115. In some embodiments, a curing time for the cured resin is dependent upon a type of the electromagnetically sensitive resin liquid 104 and the electromagnetic radiation generating device 115. In general, an appropriate electromagnetically sensitive resin liquid 104, an appropriate electromagnetic radiation wavelength or frequency, an appropriate heating temperature, or some other similar factor may be selected based upon factors such as the curing agents and accelerators mixed with the electromagnetically sensitive resin liquid 104, the resin type, the feature size of the cured resin, the intricacy or complexity of the cured resin, or some other factor. In some embodiments, the electromagnetic radiation generating device 115 may be selected based upon factors such as power, frequency, type, concentration of conductive particles, current, and coil shape.

In some embodiments, the additive manufacturing system 100 includes a controller 120. In some embodiments, the controller 120 includes a memory 122 and a processor 124. In some embodiments, the memory 122 includes program instructions which when executed by the processor 124, controls the support platform 106. In some embodiments, the controller 120 is configured to control the support platform 106 by providing a support platform instruction, included in the program instructions, to the support platform adjustment motor 108. In some embodiments, the controller 120 is further configured to control the position of the movable head 110 by providing a head instruction, included in the program instructions, to the head adjustment motor 112. In some embodiments, the program instructions, including the support platform instruction and the head instruction, are generated, and stored in the memory 122 by an operator of the additive manufacturing system 100. In some embodiments, the program instructions are configured to be dynamically adjustable, providing operational flexibility to the additive manufacturing system 100. In some implementations, the controller 120 is configured to electronically couple with the support platform adjustment motor 108 and the head adjustment motor 112.

In some embodiments, the additive manufacturing system 100 includes a power source 130. In some embodiments, the power source 130 is configured to electrically couple with the support platform adjustment motor 108, the head adjustment motor 112, the movable head 110 and the electromagnetic radiation generating device 115. In some implementations, the power source 130 may be an alternating current (AC) power source. In some embodiments, for remote operation, the power source 130 may be a direct current battery operated power source.

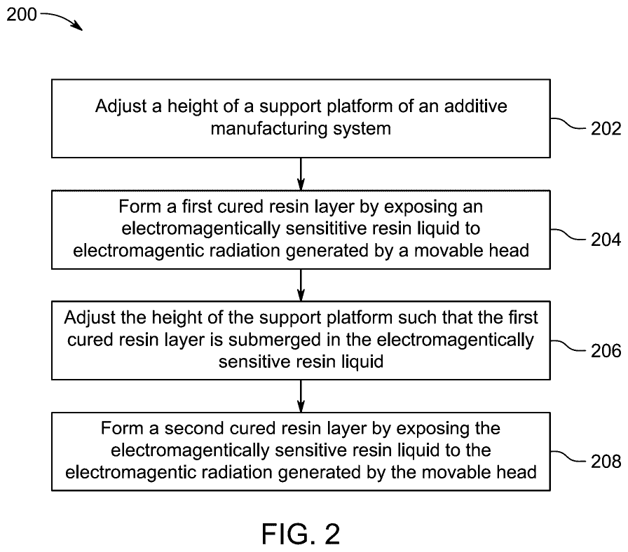

Referring to FIG. 2, a flow chart of an exemplary method 200 of forming a cured resin product is illustrated, according to certain embodiments. The order in which the method 200 is described is not intended to be construed as a limitation, and any number of the described method steps can be combined in any order to implement the method 200. Additionally, individual steps may be removed or skipped from the method 200 without departing from the spirit and scope of the present disclosure.

At step 202, the method 200 includes adjusting a height of the support platform 106 of the additive manufacturing system 100, such that the support platform 106 is submerged in the electromagnetically sensitive resin liquid 104 to a build depth below a surface of the electromagnetically sensitive resin liquid 104. In an example, the build depth refers to a dynamically adjustable depth of the support platform 106 below the surface of the electromagnetically sensitive resin liquid 104. The build depth can place a specific amount of the electromagnetically sensitive resin liquid 104 above the support platform 106. In some embodiments, the height of the support platform 106 is adjusted by the controller 120, via the support platform instruction, which when executed by the controller 120, directs the support platform adjustment motor 108 to appropriately set the height of the support platform 106 to the required build depth. In general, the build depth can be any suitable build depth. In some embodiments, the build depth is constrained by a depth of the resin bath, a thickness of the support platform, a penetration depth of the electromagnetic radiation, a power of the electromagnetic radiation generating device, or some other similar factor or combination of factors. For example, the build depth can be 0.1 mm, 0.25 mm, 0.5 mm, 0.75 mm, 1.0 mm, 1.25 mm, 1.5 mm, 1.75 mm, 2.0 mm, 2.25 mm, 2.5 mm, 2.75 mm, 3.0 mm, 3.25 mm, 3.5 mm, 3.75 mm, 4.0 mm, 4.25 mm, 4.5 mm, 4.75 mm, 5.0 mm, 5.25 mm, 5.5 mm, 5.75 mm, 6.0 mm, 6.25 mm, 6.5 mm, 6.75 mm, 7.0 mm, 7.25 mm, 7.5 mm, 7.75 mm, 8.0 mm, 8.25 mm, 8.5 mm, 8.75 mm, 9.0 mm, 9.25 mm, 9.5 mm, 9.75 mm, 10.0 mm, 10.5 mm, 11 mm, 11.5 mm, 12.0 mm, 12.5 mm, 13.0 mm 13.5 mm, 14.0 mm, 14.5 mm, 15.0 mm, 15.5 mm, 16.0 mm, 16.5 mm, 17.0 mm, 17.5 mm, 18.0 mm, 18.5 mm, 19.0 mm, 19.5 mm, 20.0 mm, 21.0 mm, 22.0 mm, 23.0 mm, 24.0 mm, or 25.0 mm.

At step 204, the method 200 includes forming a first cured resin layer by exposing the electromagnetically sensitive resin liquid 104 to electromagnetic radiation generated by the movable head 110, including the electromagnetic radiation generating device 115. The specific amount of the electromagnetically sensitive resin liquid 104 can be exposed to the electromagnetic radiation generating device 115. This exposure can heat and thereby enable curing of the exposed electromagnetically sensitive resin liquid 104 as described above. In some embodiments, the forming includes moving the movable head 110. In some embodiments, the additive manufacturing system 100 may include an infrared camera in order to monitor temperature changes that have occurred in the electromagnetically sensitive resin liquid 104. When the temperature of the electromagnetically sensitive resin liquid 104 reaches a curing temperature, the electromagnetically sensitive resin liquid 104 can solidify and thereby form the first cured resin layer. In some embodiments the first cured resin layer has a thickness equal to the build depth.

At step 206, the method 200 includes adjusting the height of the support platform 106, such that the first cured resin layer is submerged in the electromagnetically sensitive resin liquid 104. In an example, after production of the first cured resin layer, the support platform 106 is instructed via the controller 120, to move to a different depth, adjusting the support platform 106 in order to submerge the first cured resin layer. This process allows fresh, uncured electromagnetically sensitive resin liquid 104 to cover the surface of the first cured resin layer.

Further, at step 208, the method 200 includes forming a second cured resin layer by exposing the electromagnetically sensitive resin liquid 104 to electromagnetic radiation generated by the movable head 110. As such, exposing the electromagnetically sensitive resin liquid 104 to electromagnetic radiation generated by the movable head 110 causes the electromagnetically sensitive resin liquid 104 to be heated to a curing temperature of about 100° C. to 250° C., as described above. In some embodiments, the second cured resin layer is disposed on the first cured resin layer. In some embodiments, the forming includes moving the movable head 110. In some embodiments, these steps may be iteratively performed to form a plurality of subsequent cured resin layers, each disposed on a previous cured resin layer. In some embodiments, the method 200 further includes a plurality of height adjustments may be made to the support platform 106 in order to obtain a multi-layered product. The plurality of height adjustments may vary depending on a product requirement from the additive manufacturing system 100, such as a single layer product, a double layer product, or a multi-layered product. In general, each height adjustment may be the same each other or can be different from each other. The height adjustments being the same as each other can produce a cured resin product comprising layers having equal thickness.

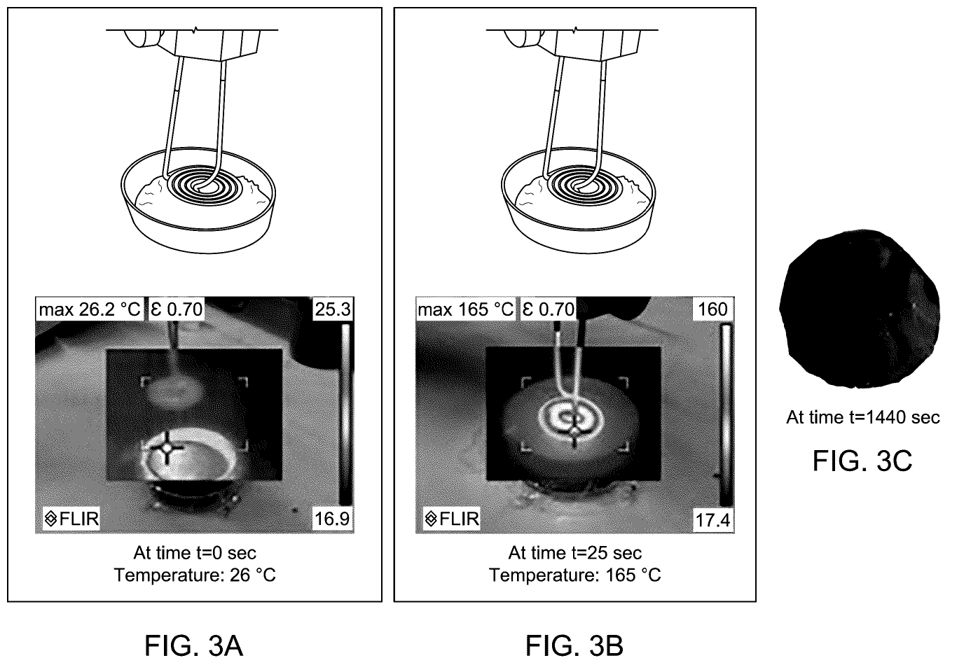

Referring to FIGS. 3A-3C, exemplary illustration of working of the additive manufacturing system 100 is illustrated, according to certain embodiments. In some implementations, the additive manufacturing system 100 is configured to operate at multiple temperatures, in order to produce desired products from a plurality of resin liquids.

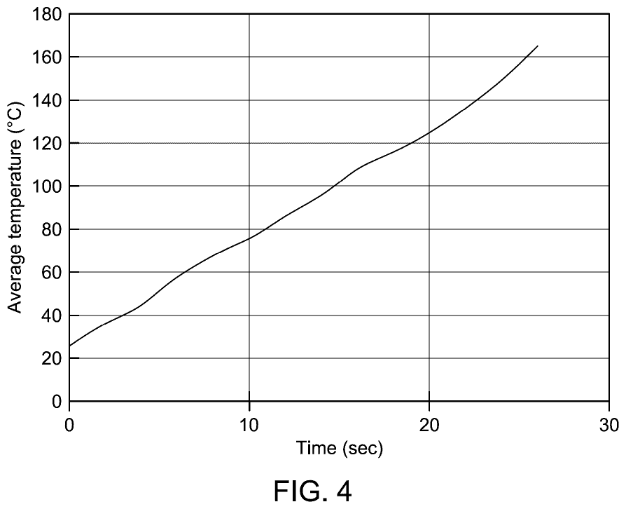

Referring to FIG. 4, a graph depicting an exemplary time-temperature relationship of an exemplary electromagnetically sensitive resin liquid 104 is illustrated, according to certain embodiments of the present disclosure.

The systems and the methods described in the present disclosure may be advantageous for lowering production costs and/or shortening manufacturing times.

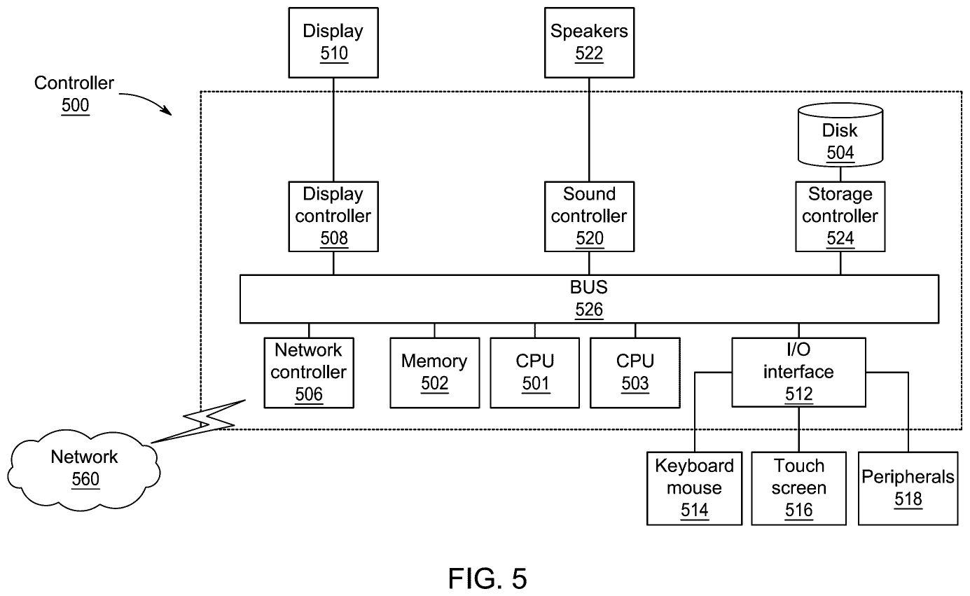

Further details of the hardware description of the computing environment according to exemplary embodiments is described with reference to FIG. 5. In FIG. 5, a controller 500 is described is representative of the controller 120 of FIG. 1A, in which the controller is a computing device which includes a CPU 501 which performs the processes described above/below. In some embodiments, the process data and may instructions be stored in memory 502. In some embodiments, these processes and instructions may alternatively or additionally be stored on a storage medium disk 504 such as a hard drive (HDD) or portable storage medium or may be stored remotely.

Further, the claimed subject matter and/or claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, in some embodiments, the claimed subject matter may be provided as, enabled by, or involve the use of a utility application, background daemon, or component of an operating system, or combination thereof, executing in conjunction with CPU 701, 703 and an operating system such as Microsoft Windows 7, Microsoft Windows 10, Microsoft Windows 11, UNIX, Solaris, LINUX, Apple MAC-OS and other systems known to those skilled in the art.

The hardware elements in order to achieve the computing device may be realized by various circuitry elements, known to those skilled in the art. For example, in some embodiments, CPU 501 or CPU 503 may be a Xenon or Core processor from Intel of America or an Opteron processor from AMD of America, or may be other processor types that would be recognized by one of ordinary skill in the art. In some embodiments, the CPU 501, 503 may be implemented on an FPGA, ASIC, PLD or using discrete logic circuits, as one of ordinary skill in the art would recognize. In some embodiments, CPU 501, 503 may be implemented as multiple processors cooperatively working in parallel to perform the instructions of the inventive processes described above.

The exemplary computing device in FIG. 5 can also includes a network controller 506, such as an Intel Ethernet PRO network interface card from Intel Corporation of America, which may be useful for interfacing with network 560. As can be appreciated, the network 560 can be a public network, such as the Internet, or a private network such as an LAN or WAN network, or any combination thereof and can also include PSTN or ISDN sub-networks. The network 560 can also be wired, such as an Ethernet network, or can be wireless such as a cellular network including EDGE, 3G, 4G and 5G wireless cellular systems. The wireless network can also be Wi-Fi, Bluetooth, or any other wireless form of communication that is known.

In some embodiments, the computing device further includes a display controller 508, such as a NVIDIA Geforce GTX or Quadro graphics adaptor from NVIDIA Corporation of America, which may be useful for interfacing with a display 510, such as a Hewlett Packard HPL2445w LCD monitor. In some embodiments, a general purpose I/O interface is included which can 512 interface with a keyboard and/or mouse 514 as well as a touch screen panel 516 on or separate from display 510. In some embodiments, a general purpose I/O interface also connects to a variety of peripherals 518 including printers and scanners, such as an Office-Jet or Desk-Jet from Hewlett Packard. In some embodiments, a sound controller 520 is also provided in the computing device such as Sound Blaster X-Fi Titanium from Creative, to interface with speakers/microphone 522 thereby providing sounds and/or music.

The general purpose storage controller 524 can connect the storage medium disk 504 with communication bus 526, which may be an ISA, EISA, VESA, PCI, or similar, for interconnecting all of the components of the computing device. A description of the general features and functionality of the display 510, keyboard and/or mouse 514, as well as the display controller 508, storage controller 524, network controller 506, sound controller 520, and general purpose I/O interface 512 is omitted herein for brevity as these features are known.

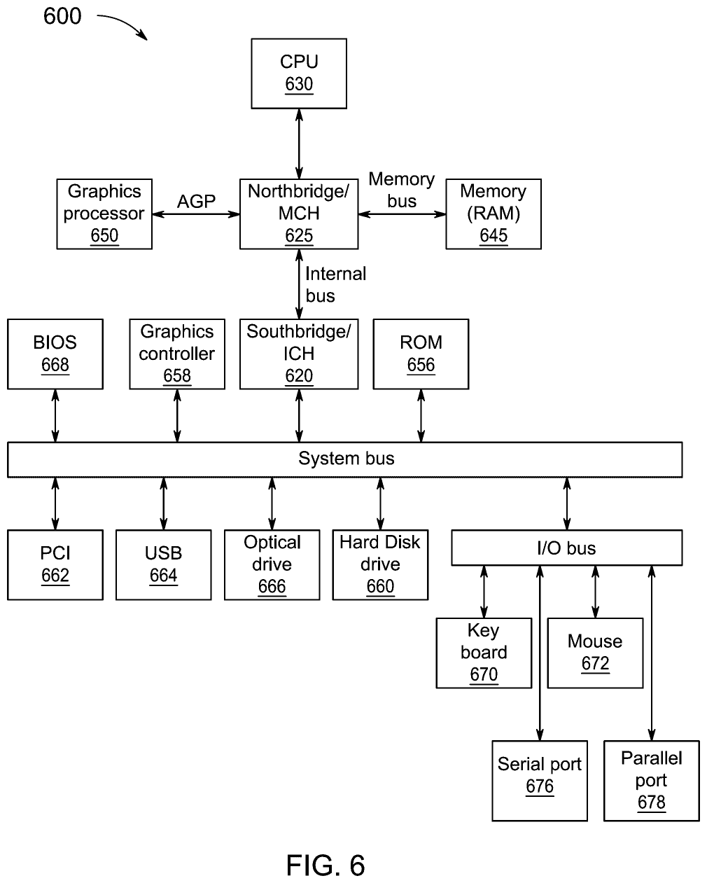

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, for example, as shown on FIG. 6.

FIG. 6 shows a schematic diagram of an exemplary data processing system, according to certain embodiments, for performing the functions of the exemplary embodiments. The data processing system is an example of a computer in which code or instructions implementing the processes of the illustrative embodiments may be located.

In FIG. 6, data processing system 600 employs a hub architecture including a north bridge and memory controller hub (NB/MCH) 625 and a south bridge and input/output (I/O) controller hub (SB/ICH) 620. The central processing unit (CPU) 630 is connected to NB/MCH 625. The NB/MCH 625 also connects to the memory 645 via a memory bus, and connects to the graphics processor 650 via an accelerated graphics port (AGP). The NB/MCH 625 can also connect to the SB/ICH 620 via an internal bus (e.g., a unified media interface or a direct media interface). The CPU Processing unit 630 may contain one or more processors and even may be implemented using one or more heterogeneous processor systems.

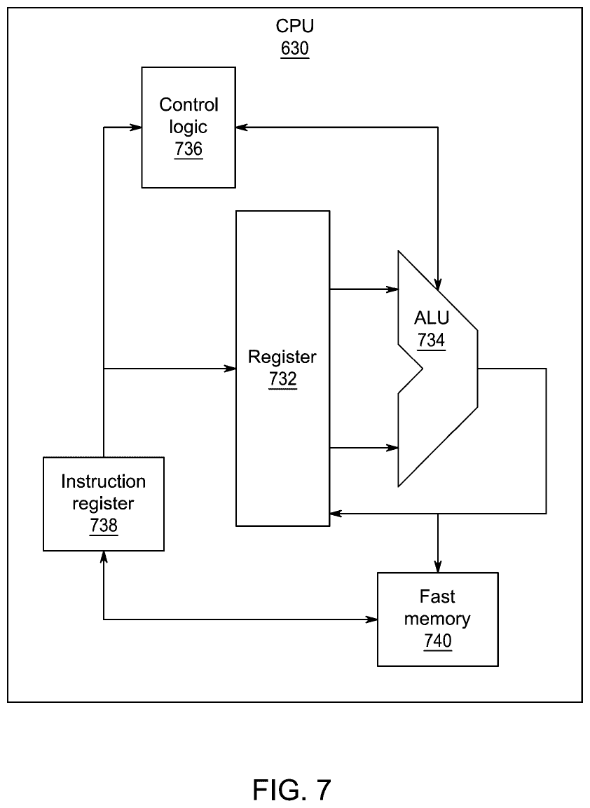

For example, FIG. 7 shows an exemplary implementation of CPU 630. In some implementations, the instruction register 738 retrieves instructions from the fast memory 740. At least part of these instructions can be fetched from the instruction register 738 by the control logic 736 and interpreted according to the instruction set architecture of the CPU 730. Part of the instructions can also be directed to the register 732. In some implementations, the instructions can be decoded according to a hardwired method. In some implementations the instructions can be decoded according to a microprogram that translates instructions into sets of CPU configuration signals that are applied sequentially over multiple clock pulses. After fetching and decoding the instructions, the instructions can be executed using the arithmetic logic unit (ALU) 734 that loads values from the register 732 and performs logical and mathematical operations on the loaded values according to the instructions. The results from these operations can be feedback into the register and/or stored in the fast memory 740. In some implementations, the instruction set architecture of the CPU 630 can use a reduced instruction set architecture, a complex instruction set architecture, a vector processor architecture, a very large instruction word architecture. Furthermore, the CPU 630 can be based on the Von Neuman model or the Harvard model. The CPU 630 can be, for example, a digital signal processor, an FPGA, an ASIC, a PLA, a PLD, or a CPLD. Further, the CPU 630 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 6, the data processing system 600 can include, for example, a SB/ICH 620 coupled through a system bus to any of an I/O Bus, a read only memory (ROM) 656, universal serial bus (USB) port 664, a flash binary input/output system (BIOS) 668, and a graphics controller 658. PCI/PCIe devices can also be coupled to SB/ICH 688 through a PCI bus 662.

The PCI devices may include, for example, Ethernet adapters, add-in cards, and PC cards for notebook computers. The Hard disk drive 660 and CD-ROM 666 can use, for example, an integrated drive electronics (IDE) or serial advanced technology attachment (SATA) interface. In one implementation the I/O bus can include a super I/O (SIO) device.

Further, the hard disk drive (HDD) 660 and optical drive 666 can also be coupled to the SB/ICH 620 through a system bus. In some embodiments, a keyboard 670, a mouse 672, a parallel port 678, and a serial port 676 can be connected to the system bus through the I/O bus. Other peripherals and devices that can be connected to the SB/ICH 620 using a mass storage controller such as SATA or PATA, an Ethernet port, an ISA bus, a LPC bridge, SM-Bus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

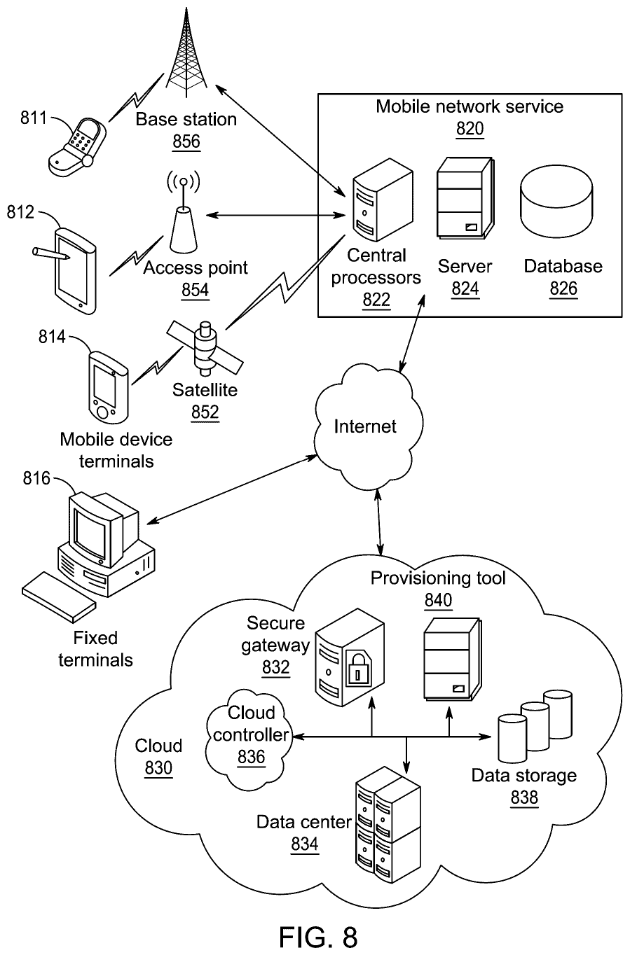

The functions and features described herein may also be executed by various distributed components of a system. For example, one or more processors may execute these system functions, wherein the processors are distributed across multiple components communicating in a network. The distributed components may include one or more client and server machines, such as cloud 830 including a cloud controller 836, a secure gateway 832, a data center 834, data storage 838 and a provisioning tool 840, and mobile network services 820 including central processors 822, a server 824 and a database 826, which may share processing, as shown by FIG. 8, in addition to various human interface and communication devices (e.g., display monitors 816, smart phones 810, tablets 812, personal digital assistants (PDAs) 814). The network may be a private network, such as a LAN, satellite 852 or WAN 854, or be a public network, may such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

### Examples

The experimental configuration depicted in FIG. 3 was constructed with a 1000 W magnetic induction heater that operates at either 110 V or 220 V. The induction heater was connected to a pan-shaped electromagnetic coil. Any conductive substance placed in the vicinity of the coil was found to be heated up due to the joule effect and hysteresis losses. The pan-type coil was positioned 5 mm away from the epoxy system. The chosen epoxy system was combined with 20% by weight of ferromagnetic nanoparticles. Ferromagnetic nanoparticles exhibit both magneto-sensitivity and conductivity. These particles produce heat by the Joule effect and hysteresis losses when exposed to electromagnetic radiation. It was evenly distributed inside the epoxy system to provide consistent heat generation throughout the epoxy medium. Due to the transparency of glass towards electromagnetic induction waves, a small glass pan made is chosen as an epoxy holder to avoid its heating. An infrared thermal camera as employed to photograph and monitor the heating procedure of the resin system.

As can be seen from FIG. 3A, the ambient temperature of the resin prior to heating by magnetic induction was about 26° C. At time ‘t’ equals to zero, the electromagnetic heating was initiated and the temperature of the electromagnetically sensitive resin liquid was about 26.2° C. As shown in FIG. 3B, at time ‘t’ equals to 25 seconds, the temperature of the electromagnetically sensitive resin liquid 104 reached about 165° C. The high temperature of 165° C. initiated crosslinking in the electromagnetically sensitive resin liquid. As shown in FIG. 3C, a cured resin product was formed after crosslinking of the electromagnetically sensitive resin liquid is complete.

The application of electromagnetic induction waves to the magneto-sensitive epoxy system led to a rapid rise in temperature. FIG. 4 depicts the correlation between time and temperature observed in the epoxy system. The temperature rapidly rose to 165° C. over a time span of 25 seconds, as per the specifications of the experimental setup. The epoxy system exposed to electromagnetic radiation underwent full curing in under 25 minutes.

Numerous modifications and variations of the present disclosure are possible in light of the above teachings. It is therefore to be understood that within the scope of the appended claims, the invention may be practiced otherwise than as specifically described herein.

1. An additive manufacturing system, comprising
a resin bath configured to contain an electromagnetically sensitive resin liquid;
a support platform having an adjustable support platform height such that the support platform can be reversibly submerged in the electromagnetically sensitive resin liquid contained in the resin bath;
a support platform adjustment motor connected to the support platform and configured to adjust the support platform height;
a movable head comprising an electromagnetic radiation generating device and positioned above the support platform and configured to not be submerged in the electromagnetically sensitive resin liquid contained in the resin bath;
a head adjustment motor connected to the movable head and configured to adjust a position of the movable head; and
a controller configured to control the support platform by providing a support platform instruction to the support platform adjustment motor and to control the position of the movable head by providing a head instruction to the head adjustment motor, wherein
the resin bath has a bath depth sufficient to allow the support platform to be submerged in the electromagnetically sensitive resin liquid such that an upper surface of the support platform is below a surface of the electromagnetically sensitive resin liquid;
the movable head is configured to be moved in a three-dimensional space above the support platform such that electromagnetic radiation generated by the electromagnetic radiation generating device is directed to a portion of the electromagnetically sensitive resin liquid contained in the resin bath directly below the movable head; and
the electromagnetic radiation from the movable head is configured to heat only the portion of the electromagnetically sensitive resin liquid contained in the resin bath directly below or and in the vicinity of the movable head and thereby cure the electromagnetically sensitive resin liquid in the portion to form a cured resin.

2. The additive manufacturing system of claim 1, wherein the electromagnetically sensitive resin liquid comprises an epoxy resin, a latent curing agent, and magneto-sensitive particles dispersed in the epoxy resin.

3. The additive manufacturing system of claim 2, wherein the magneto-sensitive particles are present in an amount of 5 to 45 wt. % based on a total weight of the electromagnetically sensitive resin liquid.

4. The additive manufacturing system of claim 2, wherein the magneto-sensitive particles are magnetic nanoparticles having a mean particle size of 5 to 500 nm.

5. The additive manufacturing system of claim 2, wherein the magneto-sensitive particles are ferromagnetic.

6. The additive manufacturing system of claim 2, wherein the magneto-sensitive particles are superparamagnetic.

7. The additive manufacturing system of claim 2, wherein the magneto-sensitive particles comprise at least one selected from the group consisting of an iron alloy, a nickel alloy, a cobalt alloy, an iron oxide, a nickel oxide, and a cobalt oxide.

8. The additive manufacturing system of claim 1, wherein the electromagnetic radiation generating device has a power of 10 W to 25000 W.

9. The additive manufacturing system of claim 1, wherein the electromagnetic radiation generating device is configured to produce a curing temperature of the electromagnetically sensitive resin liquid of 100 to 250° C.

10. The additive manufacturing system of claim 9, wherein the electromagnetic radiation generating device is configured to produce the curing temperature of the electromagnetically sensitive resin liquid within 60 seconds of initiating exposure of the electromagnetically sensitive resin liquid to the electromagnetic radiation.

11. A method of forming a cured resin product, the method comprising
adjusting a height of the support platform of the additive manufacturing system of claim 1 such that the support platform is submerged in the electromagnetically sensitive resin liquid to a build depth below a surface of the electromagnetically sensitive resin liquid;
forming a first cured resin layer by exposing the electromagnetically sensitive resin liquid to electromagnetic radiation generated by the movable head;
adjusting the height of the support platform such that the first cured resin layer is submerged in the electromagnetically sensitive resin liquid; and
forming a second cured resin layer by exposing the electromagnetically sensitive resin liquid to electromagnetic radiation generated by the movable head, wherein
the second cured resin layer is disposed on the first cured resin layer.

12. The method of claim 11, wherein
the forming includes moving the movable head, and
the method further comprises iteratively forming a plurality of subsequent cured resin layers, each disposed on a previous cured resin layer.

13. The method of claim 11, wherein the electromagnetically sensitive resin liquid comprises an epoxy resin, a latent curing agent, and magneto-sensitive particles dispersed in the epoxy resin.

14. The method of claim 13, wherein the magneto-sensitive particles are present in an amount of 5 to 45 wt. % based on a total weight of the electromagnetically sensitive resin.

15. The method of claim 13, wherein the magneto-sensitive particles are magnetic nanoparticles having a mean particle size of 5 to 500 nm.

16. The method of claim 13, wherein the magneto-sensitive particles are ferromagnetic.

17. The method of claim 13, wherein the magneto-sensitive particles are superparamagnetic.

18. The method of claim 13, wherein the magneto-sensitive particles comprise at least one selected from the group consisting of an iron alloy, a nickel alloy, a cobalt alloy, an iron oxide, a nickel oxide, and a cobalt oxide.

19. The method of claim 11, wherein the exposing the electromagnetically sensitive resin liquid to electromagnetic radiation generated by the movable head causes the electromagnetically sensitive resin liquid to be heated to a curing temperature of 100 to 250° C.

20. The method of claim 19, wherein the electromagnetically sensitive resin liquid is fully cured within 60 minutes of an initiation of the exposing.
